(19) United States
(12) Patent Application Publication
(10) Pub. No.: US 2015/0235747 A1
(43) Pub. Date: Aug. 20, 2015

(54) RARE-EARTH SINTERED MAGNET AND METHOD FOR MANUFACTURING SAME

(71) Applicant: TOYOTA JIDOSHA KABUSHIKI KAISHA, Toyota-shi, Aichi (JP)

(72) Inventors: Noritaka Miyamoto, Toyota-shi (JP); Tetsuya Shoji, Toyota-shi (JP); Kazuaki Haga, Toyota-shi (JP)

(73) Assignee: TOYOTA JIDOSHA KABUSHIKI KAISHA, Toyota-shi, Aichi (JP)

(21) Appl. No.: 14/429,447

(22) PCT Filed: Oct. 2, 2013
(86) PCT No.: PCT/JP2013/076768

§ 371 Date: Mar. 19, 2015

(30) Foreign Application Priority Data
Oct. 23, 2012 (JP) 2012-233641

(51) Int. Cl. H01F 1/057; B22F 3/12; B22F 3/26; H01F 41/02

(52) U.S. Cl. CPC H01F 1/0577; H01F 41/0266; H01F 41/0293; B22F 3/12; B22F 3/26

(57) ABSTRACT

A rare-earth sintered magnet including a relatively large main phase, and method for manufacturing same. The rare-earth sintered magnet having excellent coercive-force performance that can be manufactured without using heavy rare-earth elements such as Dy, and including: a RE-T-B main phase C (RE: Nd or Pr, T: Fe or Fe and a part thereof substituted with Co), and a grain boundary phase B surrounding the main phase C, the grain boundary phase including the RE element and the T element. The T element at the grain boundary phase B has density of 60 at % or less, and the grain boundary B has a thickness decreasing from a surface S of the rare-earth sintered magnet M to an inside thereof, and the grain boundary phase B at an area SA of a surface layer of the rare-earth sintered magnet M has an average thickness of 10 nm or more.

### TECHNICAL FIELD

The present invention relates to a rare-earth sintered magnet and a method for manufacturing the same.

### BACKGROUND ART

Rare-earth magnets containing rare-earth elements such as lanthanoide are called permanent magnets as well, and are used for motors making up a hard disk and a MRI as well as for driving motors for hybrid vehicles, electric vehicles and the like.

Indexes for magnet performance of such rare-earth magnets include remanent magnetization (residual flux density) and a coercive force. Meanwhile, as the amount of heat generated at a motor increases because of the trend to more compact motors and higher current density, rare-earth magnets included in the motors also are required to have improved heat resistance, and one of important research challenges in the relating technical field is how to keep a coercive force of a magnet during the operation at high temperatures. In the case of a Nd—Fe—B magnet that is one of the rare-earth magnets often used for vehicle driving motors, an attempt has been made to increase the coercive force of such a magnet by making crystal grains finer, by using an alloy having the composition containing more Nd and by adding heavy rare-earth elements such as Dy and Tb having high coercive-force performance, for example.

Rare-earth magnets include typical sintered magnets including the main phase (crystal) of about 1 to 8 μm in scale making up the structure, and nano-crystalline magnets including finer crystal grains of about 50 nm to 300 nm in nano-scale. Among them, rare-earth sintered magnets including the main phase having the grain size of 1 μm or more have high degree of orientation and so high remanent magnetization as well as excellent squareness.

A conventionally typical method to improve the coercive force of a rare-earth sintered magnet as stated above is to grain-boundary diffuse heavy rare-earth elements such as Dy from the surface of the magnet. Specifically fluoride or an alloy of a heavy rare-earth element such as Dy, Tb or Ho is applied to a Nd—Fe—B rare-earth sintered magnet, followed by heat treatment to diffuse the elements for penetration into the grain boundary, or these heavy rare-earth elements are heated in vacuum for evaporation, and are allowed to reach the surface of a rare-earth sintered magnet heated at 750 to 900° C., so as to diffuse these elements into the grain boundary of the rare-earth sintered magnet for penetration. That is, both of these methods are to substitute Nd at the surface of the main phase with heavy rare-earth elements such as Dy, thus increasing anisotropy magnetic field and so increasing the coercive force of the magnet.

The deposits of heavy rare-earth elements, such as Dy, however, are mostly limited in China and so there is a problem for the difficulty to acquire such elements. Further, a rare-earth sintered magnet having a (Nd, Dy)₂Fe₁₄B main phase substituted with Dy or the like becomes ferri-magnetic, in which spins of Nd and Dy are coupled in an antiparallel manner, and so the magnetization easily deteriorates unfortunately.

Then, another method may be considered as in using a HDDR magnet (HDDR: Hydrogenation Decomposition Desorption Recombination). That is, there is a method in which melt of a modifier alloy such as a Nd—Cu alloy, a Nd—Al alloy, a Nd—Cu—Al alloy, a Pr—Cu alloy, a Pr—Al alloy, or a Pr—Cu—Al alloy that are not heavy rare-earth elements and having a low melting point is diffused for penetration to the grain boundary having a crystal size at a nano-level to improve the coercive force, and such a method may be used for a rare-earth sintered magnet having a large crystalline grain size. That is, this method is to perform a heat treatment at a relatively low temperature of 500 to 650° C. so as to separate an incomplete separation state between a main phase (crystal grains) and another main phase reliably (including the case where main phases are pseudo-coupled partly because the grain-boundary phase breaks partly or the case where they are semi-coupled magnetically with the grain-boundary phase having high Fe density of 80% or more) if such a state occurs, and is to repair a defect in the main phase close to the grain-boundary phase. Such a method of grain-boundary diffuse a modifier alloy having a low melting-point has a problem that sufficient diffusion for penetration of a Nd—Cu alloy or the like is achieved only with a HDDR magnet having a main phase of about 500 nm or less or with a melt-spun magnet, and so sufficient diffusion for penetration into the grain-boundary phase cannot be expected for a magnet having a main phase of about 1 to 8 μm as in a sintered magnet under the condition of low processing temperatures at 500 to 650° C. Then, in order to achieve sufficient diffusion for penetration, heat has to be applied to be 800° C. or more, and in the case of heating to be 800° C. or more, then Fe in the main phase will be substituted with Cu and Al, resulting in deterioration of magnetic characteristics such as residual flux density adversely.

Patent Literature 1 then discloses a method for manufacturing a rare-earth permanent magnet, including performing heat treatment of alloy powder containing Ri-Mj (R is a rare-earth element including Y and Sc, M is an element of one or two types of more of Al, Si, C, P, Ti, V, Cr, Mn, Ni, Cu, Zn, Ga, Ge, Zr, Nb, Mo, Ag, In, Sn, Sb, Hf, Ta, W, Pb, and Bi, 15≦j≦99, i is balance) and an intermetallic compound phase of 70 vol % or more at the temperature of the sintered temperature of the sintered body in vacuum or in inert gas while letting such alloy powder present at the surface of a Ra-T-B sintered body (Ra is a rare-earth element including Y and Sc, T is Fe or Co) or lower.

The present inventors made an attempt to improve the magnetic characteristics of a rare-earth sintered magnet having a large main phase in size using the manufacturing method disclosed in Patent Literature 1, and obtained the result of insufficient improvement in magnetic characteristics. This is because M element in the R-M alloy penetrates through the inside of the magnet more than R element that penetrates into the grain-boundary phase.

That is, the present inventors found that it is effective to let R element only penetrate sufficiently into the inside of a magnet, and it is favorable to minimize the amount of M element penetrating or to avoid the penetration thereof. This is because an excessive amount of M element diffused into the grain-boundary phase results in the substitution of Fe making up the main phase with such M element, and so the coercive force and the magnetization both will be lowered. The present inventors further found that the thickness of a grain-boundary phase sandwiched between two main phases (thickness of two-grain boundary) greatly influences the coercive force, and the thickness of the grain-boundary phase between main phases was not able to be increased by the manufacturing method disclosed in Patent Literature 1.

### CITATION LIST

### Patent Literature

Patent Literature 1: JP 2008-263179 A

### SUMMARY OF INVENTION

### Technical Problem

In view of the aforementioned problems, the present invention relates to a rare-earth sintered magnet and a manufacturing method therefor, and aims to provide a rare-earth sintered magnet having excellent coercive-force performance that can be manufactured without using heavy rare-earth elements such as Dy, and a manufacturing method therefor.

### Solution to Problem

In order to fulfill the object, a rare-earth sintered magnet of the present invention includes: a RE-T-B main phase (RE: Nd or Pr, T: Fe or Fe and a part thereof substituted with Co), and a grain boundary phase surrounding the main phase, the grain boundary phase including the RE element and the T element. The T element at the grain boundary phase has density of 60 at % or less, and the grain boundary has a thickness decreasing from a surface of the rare-earth sintered magnet to an inside thereof, and the grain boundary phase at an area of a surface layer of the rare-earth sintered magnet has an average thickness of 10 nm or more.

The rare-earth sintered magnet of the present invention is a sintered magnet including a main phase having an average grain size of about 8 μm or less, and the grain boundary has a thickness (a thickness of a grain boundary phase sandwiched between two main phases) gradually decreasing from a surface of the rare-earth sintered magnet to an inside thereof, and the grain boundary phase at an area of a surface layer of the rare-earth sintered magnet is adjusted to have an average thickness of 10 nm or more. The grain boundary phase of a Nd sintered magnet includes a triple junction (grain boundary phase among three main phases) and a two grain boundary (grain boundary between two main phases), and conventionally the thickness of the two grain boundary has been analyzed to be about 2 nm, and such a thickness of the grain boundary phase has not been focused. The present inventors then found that the coercive force can be improved greatly when the two grain boundary has Fe+Co density or Fe density of 60 at % or less (typically around 70 at %), and the two grain boundary at the surface layer of the magnet has an average thickness of 10 nm or more.

Herein the “average grain size of the main phase” can be called an average crystalline grain size, which is found by detecting a large number of main phases in a certain area with a TEM image, a SEM image or the like of the rare-earth sintered magnet, measuring the maximum length (long axis) of the main phase on a computer and then finding the average of the long axes of the main phases.

The configuration “the grain boundary has a thickness decreasing from a surface of the rare-earth sintered magnet to an inside thereof” depends on some process of manufacturing of the rare-earth sintered magnet, in which a modifier alloy is diffused for penetration into the magnet from the surface via the grain boundary phase, whereby the thickness of the grain boundary phase at the area of the surface layer naturally becomes large, and then since the amount of the modifier alloy penetrating decreases toward the inside, the thickness of the grain boundary phase also decreases gradually.

Herein although the “area of a surface layer of the rare-earth sintered magnet” varies in the range of depth to specify the “area of a surface layer” depending on the size of the rare-earth sintered magnet and the average grain size of the main phase, this refers to the range of 100 μm to 200 μm in depth from the surface, for example. The average thickness of the grain boundary phase (two grain boundary) present at this “area of a surface layer” also can be found by a method of detecting a large number of grain boundary phases in the “area of a surface layer” with a TEM image, a SEM image or the like of the rare-earth sintered magnet, measuring the thickness of the grain boundary phases on a computer and then finding the average of the thickness of the grain boundary phases.

The grain boundary phase includes the RE element (RE: Nd or Pr) and the T element (T: Fe or Fe and a part thereof substituted with Co). The present inventors have demonstrated that when the density of the T element at the grain boundary phase, i.e., the density of ferromagnetic component element, is 60 at % or less, and the average thickness of the grain boundary phase at an area of the surface layer in the range of 100 μm to 200 μm in depth from the surface is 10 nm or more, then the rare-earth sintered magnet obtained can have high coercive-force performance without including heavy rare-earth elements such as Dy.

In a preferable embodiment of the rare-earth sintered magnet of the present invention, the grain boundary phase includes a M element in a range of 6 at % or less (M: a metal element that has a vapor pressure of 1.33×10⁻² Pa or less at a temperature of 950° C., and has a melting point in the form of a RE-M alloy that is 800° C. or less), and the M element includes any one type or two types or more of Ga, Mn and In.

The present invention includes a method for manufacturing a rare-earth sintered magnet as well, and the manufacturing method is for manufacturing a rare-earth sintered magnet including: a RE-T-B main phase (RE: Nd or Pr, T: Fe or Fe and a part thereof substituted with Co), and a grain boundary phase surrounding the main phase, the grain boundary phase including the RE element and the T element, the T element at the grain boundary phase having density of 60 at % or less, and the grain boundary having a thickness decreasing from a surface of the rare-earth sintered magnet to an inside thereof. The method includes: a first step of press-forming powder including the main phase and the grain boundary phase to prepare a sintered body: and a second step of bringing a RE-M alloy (M: a metal element that has a vapor pressure of 1.33×10⁻² Pa or less at the temperature of 950° C., and has a melting point in the form of a RE-M alloy that is 800° C. or less) into contact with the sintered body, followed by a heat treatment at a temperature that is higher than a vapor pressure curve of the M element by 50 to 200° C., and then letting melt thereof diffuse for penetration into a compact, thus manufacturing the rare-earth sintered magnet.

In order to reduce Fe density at the grain boundary phase of a Nd—Fe—B rare-earth sintered magnet (neodymium magnet), Nd may be allowed to penetrate into the grain boundary phase so as to dilute or expel Fe. Simply bringing Nd into contact with the surface for melting, however, has a problem of making the main phase of the magnet coarse because it has a high melting point (1,024° C.). Then, a modifier alloy including Nd in the form of an alloy (RE-M alloy) may be used, whereby a melting point at 700° C. or less can be realized. Then, in the manufacturing method of the present invention, a heat treatment is performed at a temperature that is higher than the melting point of this modifier alloy and is higher than a vapor pressure curve of the M element by 50 to 200° C. Note here that the M element in the grain boundary phase, when the content thereof exceeds 10 at %, tends to enter into the main phase and is substituted for Fe. That is, a small amount of the M element may increase the coercive force, but too much amount of the M element may degrade the coercive force or the magnetization greatly.

Then, in the manufacturing method of the present invention, the heat treatment is performed under the condition that is higher than the vapor pressure curve of the M element by 50 to 200° C., whereby Nd-M is allowed to fuse and Nd is allowed to penetrate into the grain boundary phase of the magnet, and then the M element is allowed to evaporate which can be trapped with a trap filter or the like of a vacuum device, for example. It was found that, if the temperature for the heat treatment is less than +50° C. of the melting point, Nd cannot penetrate sufficiently, and the grain boundary phase of 10 nm in average thickness cannot be obtained. On the other hand, if the temperature for the heat treatment is higher than +200° C., the M element evaporates too soon, and the amount of the M element decreases prior to the penetration of Nd into the grain boundary phase, meaning an increase of the melting point and solidification of the Nd-M alloy.

The M elements having a vapor pressure of 1.33×10⁻² Pa or less at a temperature of 950° C. include Ag, Al, Be, Cu, Dy, Er, Ga, In, Mn, Sc, and Sn, and among them, Be does not form an alloy, and Dy, Er and Sc are an all proportional solid solution without having a eutectic point, and so these elements are not suitable. Further Al and Cu have a too small amount of evaporation at 800° C. or more, and so they penetrate in the state of liquid of Nd—Cu and Nd—Al, meaning that too much amount of Cu and Al is substituted with Fe, which may degrade both of the coercive force and the magnetization.

Then, Ag, Ga, Mn and In may be selected as the metal element (M element) having a vapor pressure of 1.33×10⁻² Pa or less at a temperature of 950° C. and having a melting point in the form of a RE-M alloy that is 800° C. or less, and further considering the material cost, any one type or two types or more of Ga, Mn and In is selected preferably.

When the RE-M alloy is brought into contact with the sintered body at the second step for heat treatment, this RE-M element may be in a sheet form or a powder form (paste form). The amount of the M element contained in the (Nd, Pr)-M alloy (M denotes any one type of Ga, Mn and In, and it mostly evaporates at the temperatures of 800 to 1,000° C.) is 20 at % or less with reference to the (Nd, Pr)-M alloy as a whole as 100, desirably 15 at % or less. For instance, when the heat treatment is performed at the degree of vacuum of 1.33 Pa or more and for 1 to 48 hours, the (Nd, Pr)-M alloy is molten, and the M element is vaporized so that most of it is dispersed. Whereas Nd or Pr having density that is larger than that in the original alloy is diffused for penetration into the magnet, and especially a thick grain boundary phase with low density of Fe can be formed effectively.

### Advantageous Effects of Invention

As can be understood from the above descriptions, the rare-earth magnet of the present invention having the configuration of the density of Fe or Fe+Co element at the grain boundary phase being 60 at % or less, and the average thickness of the grain boundary phase at an area of the surface layer being 10 nm or more can have high coercive-force performance without including heavy rare-earth elements such as Dy. The manufacturing method of a rare-earth sintered magnet of the present invention includes the step of bringing a RE-M alloy (M: a metal element that has a vapor pressure of 1.33×10⁻² Pa or less at the temperature of 950° C., and has a melting point in the form of a RE-M alloy that is 800° C. or less) into contact with the sintered body, followed by a heat treatment at a temperature that is higher than a vapor pressure curve of the M element by 50 to 200° C., whereby a rare-earth sintered magnet of the present invention having the grain boundary phase at an area of the surface layer having an average thickness of 10 nm or more can be manufactured.

### BRIEF DESCRIPTION OF DRAWINGS

FIG. 1 illustrates the vapor pressure curve of Ga and the appropriate temperature range for the heat treatment.

FIG. 2 illustrates the relationship of anisotropy (magnetic characteristics base on it) and the metal composition of a neodymium magnet at a room temperature

FIG. 3 illustrates the vapor pressure curve of various M elements, showing the optimum temperature range and vapor pressure range for the manufacturing method of the present invention.

FIG. 4a schematically illustrates a rare-earth sintered magnet, and FIG. 4b is a cross-sectional view that is an enlarged view of part b in FIG. 4a, illustrating thicknesses of a grain boundary phase at an area at the surface layer and at an area deeper than that.

FIG. 5 schematically describes a method for manufacturing a rare-earth sintered magnet in the experiment.

FIG. 6 illustrates the result of an experiment relating to magnetic characteristics of test bodies of Comparative examples and examples.

FIG. 7 is an equilibrium diagram of a Nd—Al alloy.

FIG. 8 illustrates the relationship between the heat-treatment temperatures of various modifier alloys and the coercive forces of rare-earth sintered magnets manufactured.

FIG. 9 illustrates SEM images of rare-earth sintered magnets manufactured by heat treatment applied to various modifier alloys shown in FIG. 8.

FIG. 10 illustrates a SEM image of a rare-earth sintered magnet manufactured by heat treatment applied to one type of modifier alloy shown in FIG. 8, and an enlarged view of a part thereof with a FE-SEM image.

FIG. 11 illustrates the observation position of the SEM image in FIG. 10.

FIG. 12 illustrates the result of EDS analysis before heat treatment.

FIG. 13 is an equilibrium diagram of a Nd—Ga alloy.

FIG. 14 shows the degree of improvement in coercive force, while comparing a rare-earth sintered magnet including a Nd—Ga alloy with a rare-earth sintered magnet that is not modified with a modifier alloy.

FIG. 15 illustrates the result of the experiment to find the relationship between the size of a main phase of a rare-earth sintered magnet and the coercive force.

### DESCRIPTION OF EMBODIMENTS

Referring to the drawings, the following describes embodiments of a rare-earth magnet of the present invention, and a manufacturing method therefor.

(Embodiment of Rare-Earth Sintered Magnet and Manufacturing Method Therefor)

The manufacturing method of a rare-earth sintered magnet of the present invention includes, as a first step, to press-form powder to form a sintered body, the powder including a RE-T-B main phase (RE: Nd or Pr, T: Fe or Fe and a part thereof substituted with Co) and a grain boundary phase including an RE element and a T element surrounding the main phase.

Next, as a second step, a RE-M alloy (M: a metal element that has a vapor pressure of 1.33×10⁻² Pa or less at the temperature of 950° C., and has a melting point in the form of a RE-M alloy that is 800° C. or less) is brought into contact with the sintered body prepared at the first step, followed by a heat treatment at a temperature that is higher than the vapor pressure curve of the M element by 50 to 200° C., and then, melt thereof is diffused for penetration into the compact, thus manufacturing a rare-earth sintered magnet.

For the RE-M alloy as a modifier alloy that is used at the second step, any one type or two types or more of Ga, Mn and In is selected for the M element.

In the heat treatment, the modifier alloy is brought into contact with the sintered body, and then the heat treatment is performed in the vacuum atmosphere. In this heat treatment, the degree of vacuum and the temperature are adjusted so that the speed of the RE element to be diffused to the magnet is equal to the speed of evaporation of the M element as the heat treatment conditions in the vacuum atmosphere.

Then, the amount of the M element in the RE-M alloy is 20 at % or less, desirably 15 at % or less. The modifier alloy may be disposed with respect to the sintered body in such a manner that a thin sheet-form alloy is cut out from an ingot with a multi-cutter wire saw or the like to be modifier alloy piece, and this is placed on the sintered body for heat treatment, or powder obtained by grinding an ingot is made to be a paste form, which then may be applied on the surface of a magnet. Alternatively, gas-atomized or centrifugal-atomized powder, for example, may be made to be a paste form for this purpose.

The following describes the temperature and the degree of vacuum during the heat treatment at the second step in details.

In order to reduce Fe density at the grain boundary phase of a Nd—Fe—B rare-earth sintered magnet (neodymium magnet), Nd may be allowed to penetrate into the grain boundary phase so as to dilute or expel Fe. Simply bringing Nd into contact with the surface for melting, however, has a problem of making the main phase of the magnet coarse because it has a high melting point (1,024° C.). Then, a modifier alloy including Nd in the form of an alloy (RE-M alloy) may be used, whereby a melting point at 700° C. or less can be realized.

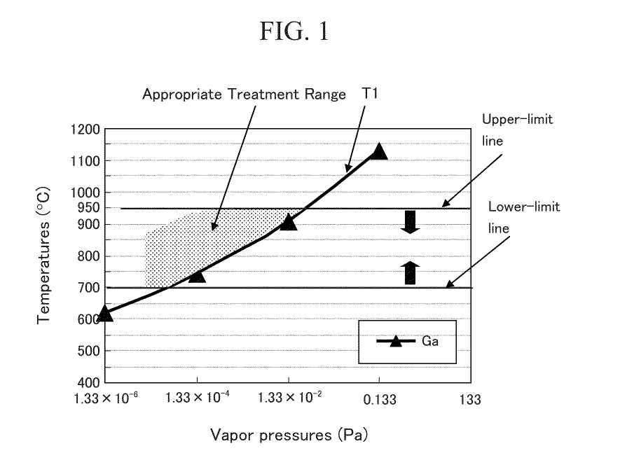

FIG. 1 illustrates the vapor pressure curve of Ga and the appropriate temperature range for the heat treatment. For the heat treatment at the second step, the treatment is performed at a temperature that is higher the melting point of the Nd—Ga alloy and is higher than the vapor pressure curve of Ga illustrated in the drawing by 50 to 200° C.

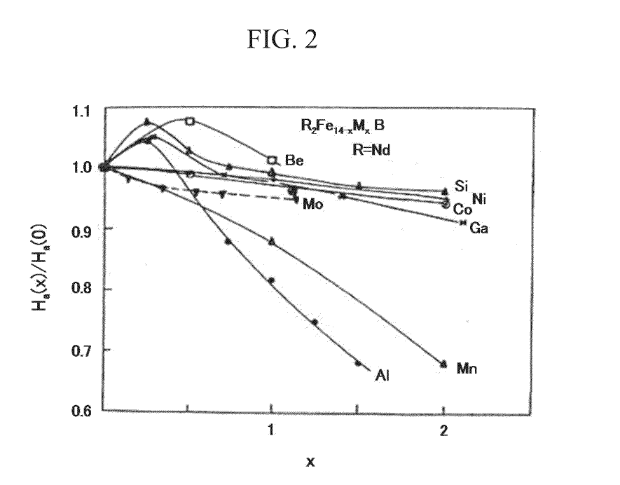

Note here that the M element in the grain boundary phase, when the content thereof exceeds 10 at %, tends to enter into the main phase and is substituted for Fe. That is, as is evident from FIG. 2 illustrating the relationship between anisotropy (magnetic characteristics base on it) and the metal composition of a neodymium magnet at a room temperature, a small amount of the M element may increase the coercive force, but too much amount of the M element may degrade the coercive force or the magnetization greatly.

Then, the heat treatment is performed under the condition that is higher than the vapor pressure curve of Ga as one of the M elements by 50 to 200° C., whereby Nd—Ga is allowed to fuse and Nd is allowed to penetrate into the grain boundary phase of the magnet, and then Ga is allowed to evaporate which can be trapped with a trap filter or the like of a vacuum device, for example.

It was found that, if the temperature for the heat treatment is less than +50° C. of the melting point, Nd cannot penetrate sufficiently, and the grain boundary phase of 10 nm in average thickness at an area of the surface layer, which is a feature of the configuration of the rare-earth sintered magnet of the present invention described later, cannot be obtained. On the other hand, if the temperature for the heat treatment is higher than +200° C., Ga evaporates too soon, and the amount of Ga decreases prior to the penetration of Nd into the grain boundary phase, meaning an increase of the melting point and solidification of the Nd—Ga alloy.

When the temperature for the heat treatment exceeds the upper-limit line of FIG. 1, the main phase increases in size rapidly, and the squareness and the coercive force deteriorate. On the other hand, when the temperature for the heat treatment falls below the lower-limit line of the drawing, it is close to the melting point (675° C.) of Nd—Fe that is a main component of the grain boundary phase, and so Nd is diffused to enter into the grain boundary, meaning a failure to increase the thickness of the grain boundary phase between main phases and a failure in penetration deeply into the magnet.

Considering the above, the processing temperature and the time for the heat treatment are set at about 800 to 1,000° C. and about 1 to 48 hours while further considering the size and the thickness of a sintered body.

Examples of the M element include Ag, Al, Cu, Ga, In, Mn, and Sn, and Table 1 below shows the vapor pressure curve of each element and the melting point of a modifier alloy of each element and Nd.

TABLE 1

| | Melting point |
|---|---|
| Type of | (eutectic point) |
| modified alloy | (° C.) |
| Nd-20 at % Ag | 648 |
| Nd-15 at % Al | 635 |
| Nd-30 at % Cu | 520 |
| Nd-20 at % Ga | 650 |
| Nd-15 at % In | 880 |
| Nd-27 at % Mn | 695 |
| Nd-17 at % Sn | 868 |

Ga, Mn and In are selected from a lot of M elements because they satisfy the conditions that it has a vapor pressure of 1.33×10⁻² Pa or less at the temperature of 950° C., and has a melting point in the form of a RE-M alloy that is 800° C. or less, i.e., they are selected because they can form an alloy and are not an all proportional solid solution, for example, while considering the material cost, for example.

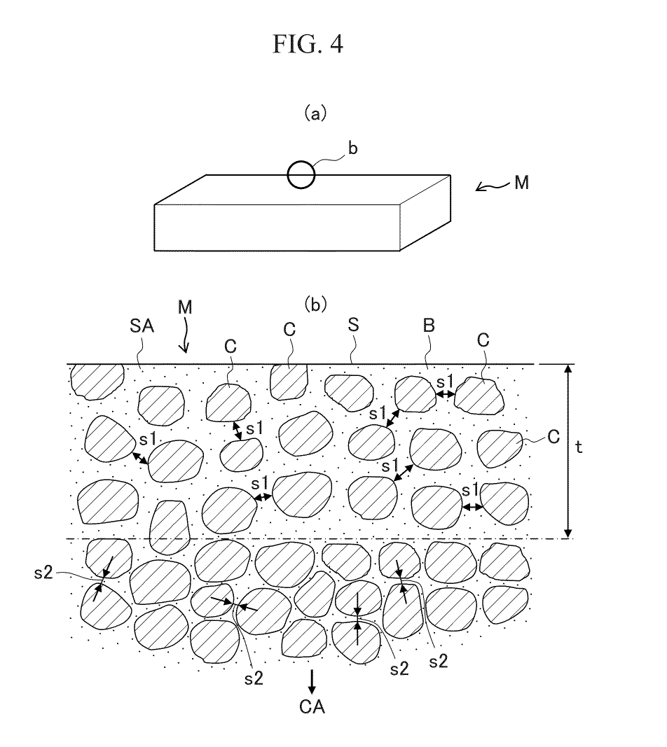

A rare-earth sintered magnet of the present invention can be manufactured by the manufacturing method as stated above. FIG. 4a schematically illustrates a rare-earth sintered magnet, and FIG. 4b is a cross-sectional view that is an enlarged view of part b in FIG. 4a, illustrating thicknesses of a grain boundary phase at an area at the surface layer and at an area deeper than that.

As illustrated in FIG. 4b, a rare-earth sintered magnet M shows a metal structure, including a RE-T-B main phase (RE: Nd or Pr, T: Fe or Fe and a part thereof substituted with Co) of 1 to 8 μm in average grain size, and a grain boundary phase B between main phases C and including an RE element and a T element.

Then, in the rare-earth sintered magnet M manufactured by the method as stated above, the width of the grain boundary phase B gradually decreases from the surface layer S toward a center area CA of the magnet, and at the area SA of the surface layer that is in the range of 100 to 200 μm in the depth t from the surface layer S, the average thickness calculated by averaging the thicknesses s1 at various parts of the grain boundary phase B is 10 nm or more.

Then the average density of Fe or Fe+Co at the grain boundary phase B is 60 at % or less.

For the RE-T-B main phase (RE: Nd or Pr, T: Fe or Fe and a part thereof substituted with Co), the main phase may have the component composition, based on (Nd, Pr)₂—(Fe, Co)₁₄-B₁, in the range of 29 mass %≦Nd+Pr≦33 mass %, 0 mass %≦Co≦6 mass %, 0 mass %≦Al≦0.2 mass %, 0 mass %≦Cu≦0.4 mass %, 64 mass %≦Fe≦69 mass %, 5.5 mass %≦B≦6.3 mass %, and O₂≦4,000 ppm. The main phase preferably has the average grain size of 8 μm or less, more preferably 5 μm or less and desirably 3.5 μm or less.

The coercive force can be improved greatly when the two grain boundary has Fe+Co density or Fe density of 60 at % or less (typically around 70 at %), and the two grain boundary at the surface layer of the magnet has an average thickness of 10 nm or more. If the Fe density at the grain boundary phase is high, it increases a magnetically soft tendency, meaning that when it is placed in the magnetic field, spins will rotate following the magnetic field, and reverse magnetic domains are generated at the main phase in the vicinity and magnetization reversal easily occurs. Then while the Fe density may be reduced as much as possible and the magnetic properties of the grain boundary phase may be decreased, complete magnetically shut-down can be achieved with a thick grain boundary phase. Further, when the grain boundary phase may have a large Nd density and may be thick, a facet can be formed around the main phase of several μm in size. Such a facet formed will correct a lattice defect that might by the origin of reverse magnetic domains or will remove crystal strains.

Referring back to FIG. 4b, at the center area CA deeper than the area SA of the surface layer, the thickness s2 of the grain boundary phase B between main phases is smaller than the thickness s1 of the grain boundary phase B between main phases at the area SA of the surface layer.

According to the rare-earth sintered magnet M illustrated, the density of Fe or Fe+Co at the grain boundary phase is 60 at % or less, and the average thickness of the grain boundary phase at an area of the surface layer of the rare-earth sintered magnet is 10 nm or more. Thereby, such a rare-earth sintered magnet can have high coercive-force performance without including heavy rare-earth elements such as Dy.

[Experiment to Measure Magnetic Characteristics of Rare-Earth Sintered Magnet Manufactured by the Manufacturing Method of the Present Invention, and Result Thereof]

The present inventors prepared test bodies of a rare-earth sintered magnet according to Comparative examples and examples by the following method and measured magnetic characteristics of these test bodies.

(Method for Preparing Test Bodies) Test bodies were prepared by performing continuous casting by strip casting, and then performing hydrogen grinding thereto, followed by grinding with a jet mill to have an average size of 3.5 μm. Then orientation was formed in the magnetic field, and was sintered at 1,050° C., to which heat treatment was performed for finishing at 500° C. for 1 hour. Then the resultant was polished for finishing to be in the size of 70×15×5 mm (easy magnetization direction was 5 mm). This test body had the composition of Nd: 24.31, Pr: 6.64, Co: 2.13, Al: 0.07, Cu: 0.1, O (oxygen): 0.14 all in terms of at %. This magnet had magnetic characteristics of Hcj: 10 kOe, and Br: 1.44 T before low-temperature heat treatment.

Next, gravity casting was performed to a modifier alloy shown in Table 2 to have the size of 200×200×20 mm, which was then cut by a wire saw to be 70×15×0.3 mm in size, thus preparing a bulk of the modifier alloy (having the size corresponding to 6 wt % with reference to the magnet).

TABLE 2

| | | (Ref.) | | Treat- | Treat- |
|---|---|---|---|---|---|
| | | Melting | Vacuum | ment | ment |
| | Modified | point | degree | temp. | duration |
| | alloy | (° C.) | (Pa) | (° C.) | (time) |
| Comp. Ex. 1 | Nd-15 | 635 | 1.33 × 10⁻⁴ | 900 | 15 |
| | at % Al | | | | |
| Comp. Ex. 2 | Nd-30 | 520 | | 950 | |
| | at % Cu | | | | |
| Comp. Ex. | Nd-67 | 1460 | | | |
| 3-1 | at % Al | | | | |
| Comp. Ex. | | | | 800 | 1 |
| 3-2 | | | | | |
| Ex. 1-1 | Nd-20 | 650 | | 850 | 15 |
| | at % Ga | | | | |
| Ex. 1-2 | Nd-15 | 880 | | | |
| | at % In | | | | |
| Ex. 1-3 | Nd-27 | 695 | | 750 | |
| | at % Mn | | | | |
| Ex. 1-4 | Nd-17 | 868 | | 900 | |
| | at % Sn | | | | |

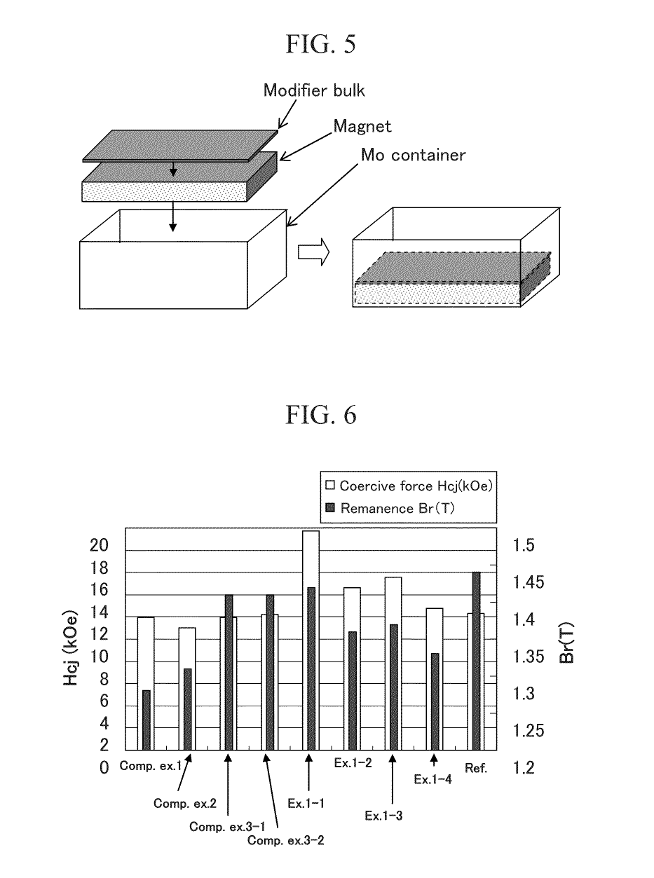

Next as illustrated in FIG. 5, a magnet and a bulk of the modifier alloy were placed in a container for the preparation of a heat treatment. Specifically the bulk of the modifier alloy was disposed on the magnet, and the heat treatment was performed under the conditions described in Table 2 so that each element had substantially same vapor pressure (around 1.33×10⁻³ Pa) based on the vapor pressure curves. For Comparative example 3-1 in Table 2, this had the composition of the modifiers that were used in Examples 1 and 3 of Patent Literature 1 described above. Comparative example 3-2 was prepared under the processing condition corresponding to the disclosure in Patent Literature 1. They were heat-treated at a low temperature of 500° C. that is a typical temperature for the treatment of sintered magnets, and were cut out into test pieces of 5×5×5 mm in size for measurement of the magnetic characteristics. Table 3 below and FIG. 6 show the result of the magnetic measurements.

TABLE 3

| | Modified | Coercive force Hcj | Remanence Br |
|---|---|---|---|
| | alloy | (kOe) | (T) |
| Comp. Ex. 1 | Nd-15 at % Al | 12 | 1.28 |
| Comp. Ex. 2 | Nd-30 at % Cu | 11 | 1.31 |
| Comp. Ex. | Nd-67 at % Al | 11.9 | 1.41 |
| 3-1 | | | |
| Comp. Ex. | | 12.2 | 1.41 |
| 3-2 | | | |
| Ex. 1-1 | Nd-20 at % Ga | 19.5 | 1.42 |
| Ex. 1-2 | Nd-15 at % In | 14.6 | 1.36 |
| Ex. 1-3 | Nd-27 at % Mn | 15.6 | 1.37 |
| Ex. 1-4 | Nd-17 at % Sn | 12.8 | 1.33 |
| Ref. | Not modified | 12.3 | 1.44 |

Note:
For conversion of the unit of coercive force kOe into the International System of Unit (SI) (kA/m), the coercive force was calculated by multiplying it by 79.6.

The test body not subjected to diffusion had the value of 10 kOe before the heat treatment and had 12.3 kOe after the heat treatment, and examples and comparative examples are compared with this as follows.

For the object to improve a coercive force, the result of Table 3 and FIG. 6 shows that the test body including a modifier alloy containing Ga in Example 1-1 had the best result, followed by those containing In and Mn. Then, the test bodies including other elements showed the result of ineffectiveness or rather deterioration in the value.

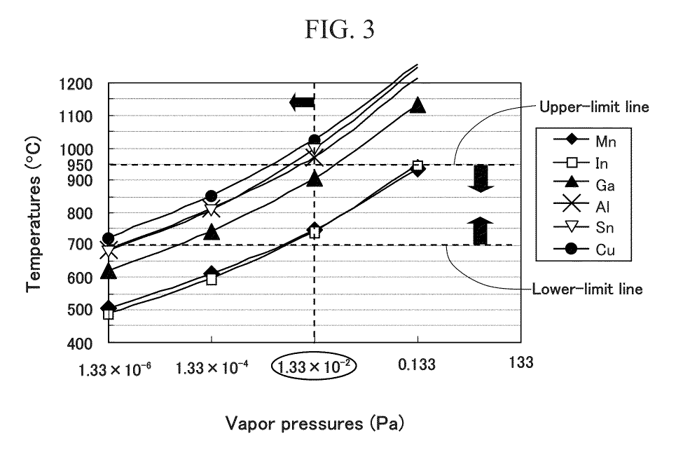

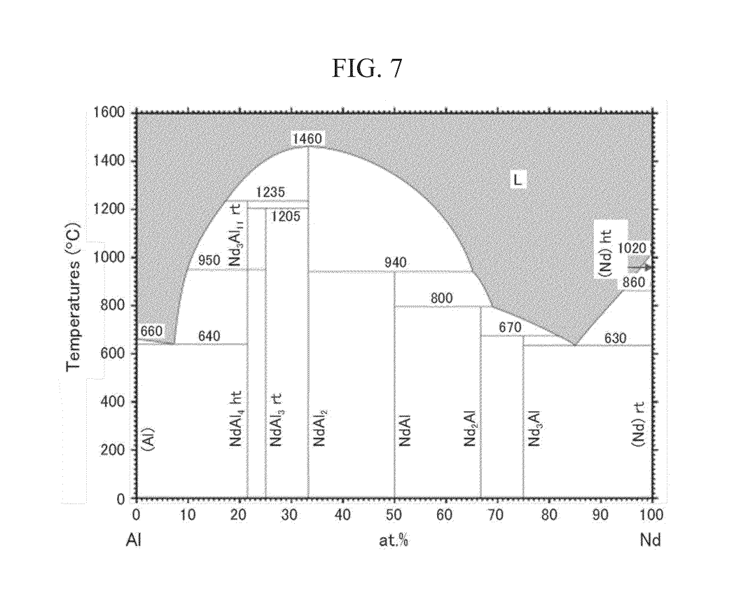

In the method disclosed in Patent Literature 1, as is evident from the equilibrium diagram of a Nd—Al alloy in FIG. 7, the alloy Nd33Al67 used has a high melting point, and so melting of the material did not proceed sufficiently, and the amount of diffusion into the magnet also was small. Then, when Nd-15 at % Al having a lower melting point due to Al contained is used, melting proceeded, and it was diffused into the magnet. However, since Al has a relatively high vapor pressure and the amount of evaporation also is small with reference to FIG. 3, such Al mostly penetrated into the grain boundary phase prior to evaporation. It was confirmed that this entered into the main phase in the form of substitution with Fe. That is why Br of the magnet was degraded greatly.

[Experiment to Examine Influences of Low Heat Treatment Temperatures on Magnetic Characteristics and Result Thereof]

The present inventors further examined the influences of low heat treatment temperatures on magnetic characteristics while changing the low heat treatment temperatures for Example 1-1 and Comparative Example 1, whereas heat treatment was performed in Example 1 while setting the low heat treatment temperature constant at 500° C., and then observed their structures of the magnets.

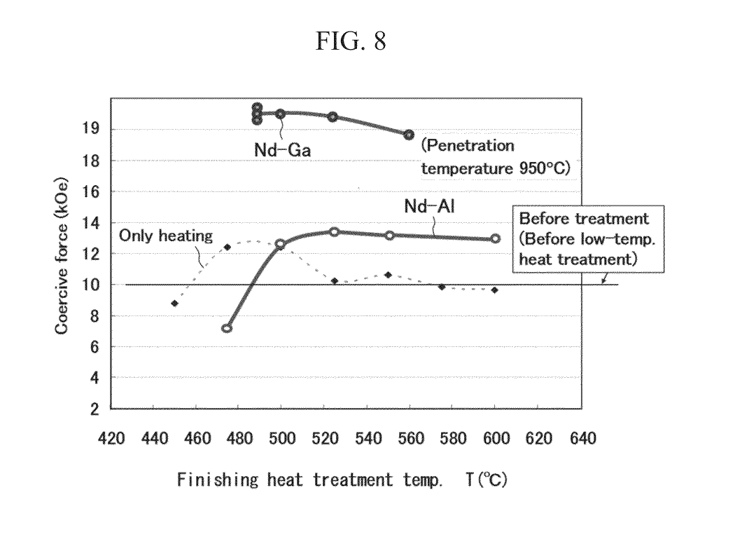

This experiment additionally included, as data, 487° C., 525° C., and 560° C. for Nd-20% Ga, and 480° C., 525° C., 550° C., and 600° C. for Nd-15% Al. FIG. 8 shows the result of this experiment.

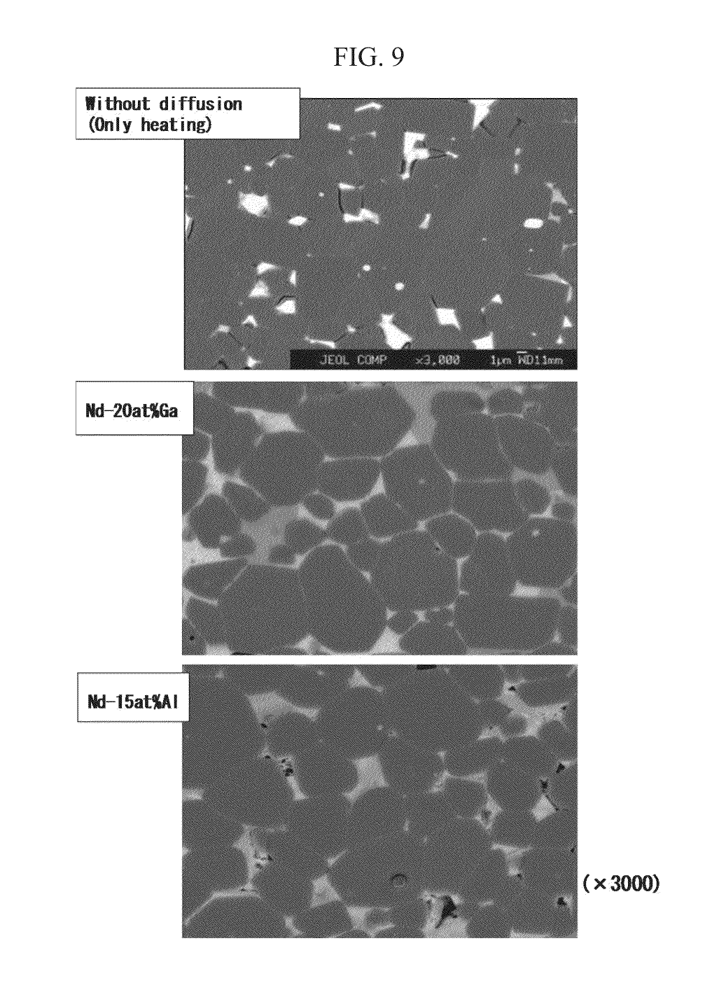

As shown in FIG. 8, the optimum temperature varied a little between Nd—Ga and Nd—Al, but Nd—Ga(Nd-20% Ga) had higher values over the entire area. Then, the test bodies subjected to low-temperature heat treatment at 520° C. were observed with SEM. FIG. 9 shows the result of observations in comparison with the test body without diffusion.

As in the drawing, the test bodies without diffusion and of Nd-15% Al had their grain boundary phases that were fine similar to those before the treatment, which cannot be seen clearly with this magnification. Whereas, the grain boundary phase of the test body of Nd-20% Ga can be clearly observed. That is, this shows that the two grain boundary sandwiched between main phases also is thick.

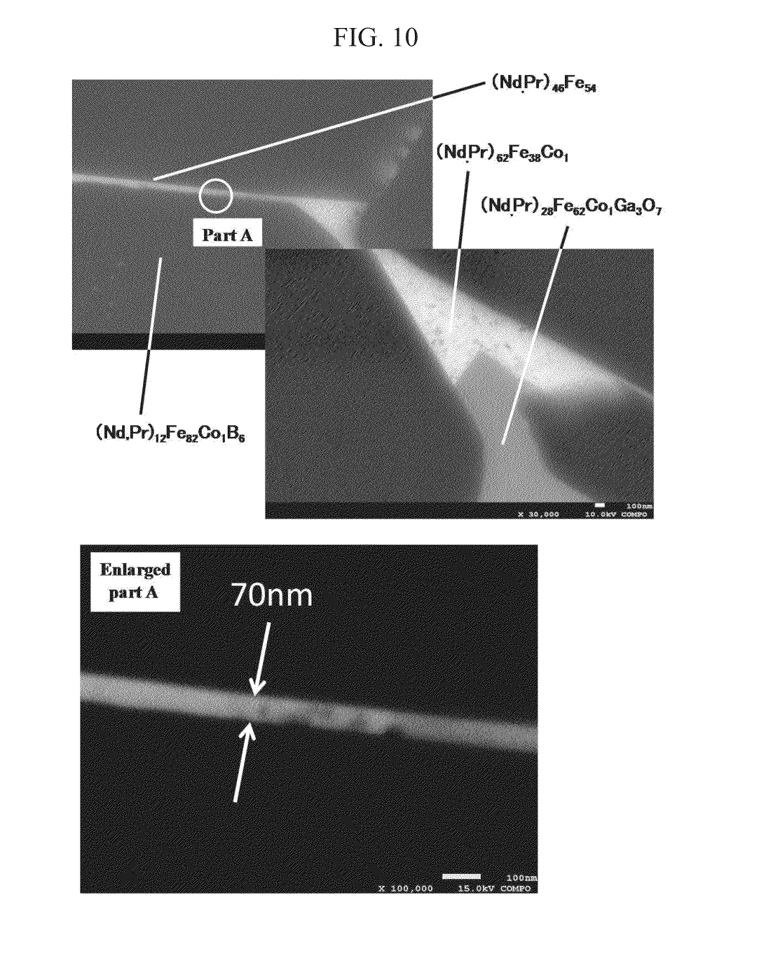

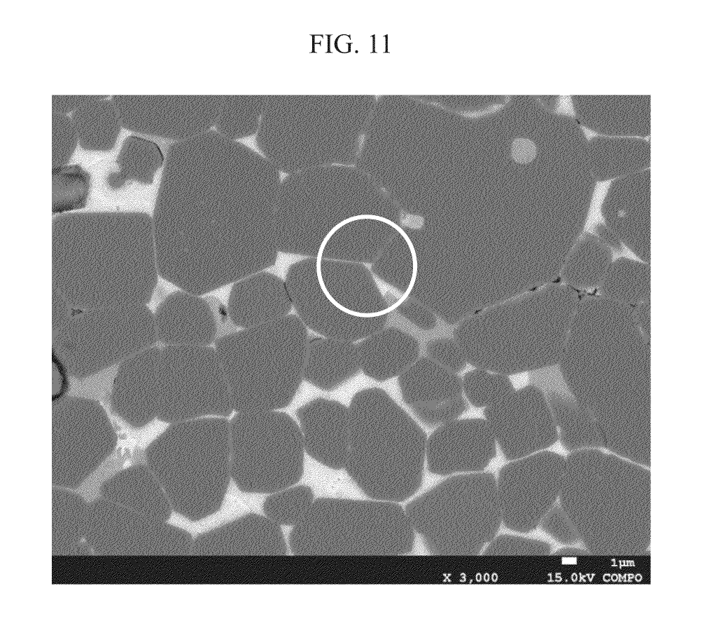

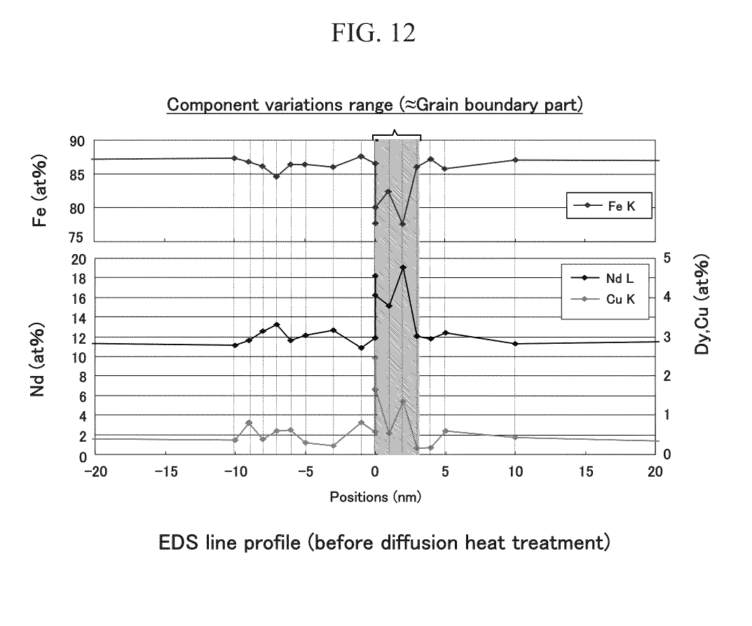

FIG. 10 shows SEM images of a rare-earth sintered magnet of Nd-20% Ga and subjected to the heat treatment (upper in FIG. 10), and shows an enlarged view of a part thereof as a FE-SEM image (lower in FIG. 10). FIG. 12 shows a result of EDS analysis of a part in the vicinity of the grain boundary of the magnet before the treatment as reference. FIG. 11 shows the part observed in the upper diagram of FIG. 10 (the range surrounded with the circle in the drawing corresponds to the upper diagram in FIG. 10).

Conventionally analyses show that two grain boundary before the treatment had a thickness of about 2 to 4 nm in any data. Then, the two grain boundary in this experiment shown in FIG. 12 before the treatment also had a thickness of 3 nm, which matches with the conventional analysis data.

That compares with that the thickness of the two grain boundary that was obtained by the heat treatment in this experiment had 50 nm or more at many parts, and the average thereof can be estimated 10 nm or more at least. The two grain boundary in the lower diagram of FIG. 10 had a thickness of about 70 nm, and no two grain boundary having such a thickness was observed in sintered magnets manufactured by conventional manufacturing methods, comparative examples in Table 2 and Examples 1 to 4.

[Experiment to Examine Magnetic Characteristics when the Ratio of Components of Nd—Ga Alloy is Changed, and Result Thereof]

The present inventors conducted an experiment to measure magnetic characteristics of rare-earth sintered magnets manufactured by changing the ratio of components of Nd—Ga, whereas the alloy components were fixed in the two types of experimented as stated above. Table 4 below shows the alloy compositions to be evaluated.

TABLE 4

| Modifier alloy | Modifier alloy |
|---|---|
| composition | melting point |
| (at %) | (° C.) |
| Nd-92 at % Ga | 620 |
| Nd-50 at % Ga | 1200 |
| Nd-45 at % Ga | 1050 |
| Nd-40 at % Ga | 940 |
| Nd-30 at % Ga | 860 |
| Nd-25 at % Ga | 820 |
| Nd-20 at % Ga | 650 |
| Nd-14 at % Ga | 770 |
| Nd-10 at % Ga | 860 |
| Nd-5 at % Ga | 940 |
| Nd-0 at % Ga | 1020 |
| Not modified | — |

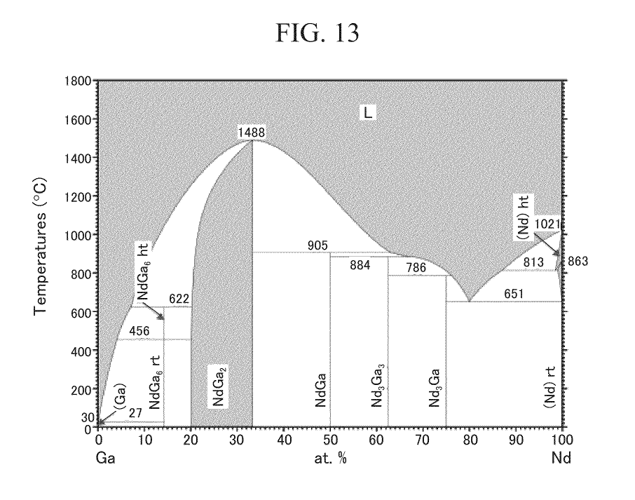

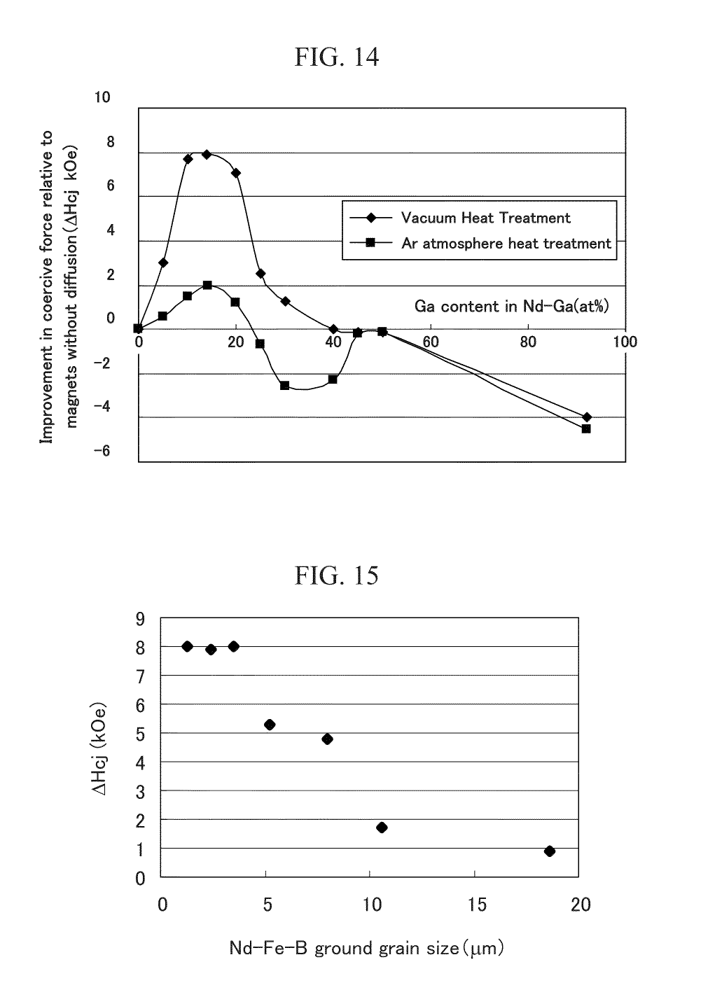

In this experiment, a modifier alloy was casted in a book mold of 200×200×20 mm in size, which was then coarse-ground with a jaw crusher, and further fine-ground with a pinmill so that the resultant had a grain size of 105 μm or less. Then, such powder was mixed with paraffin, and then was heated to be a paste form, the amount corresponding to 6 mass % of which was applied to the surface of the magnet described in Example 1 with a die coater for solidification. Then, heat treatment was performed under the condition of 980° C.×10 hours at 1.33×10⁻⁴ Pa and in Ar atmosphere at the atmospheric pressure, followed by low-temperature heat treatment at 500° C. Table 5 below and FIG. 14 show the result. FIG. 13 is an equilibrium diagram of a Nd—Ga alloy as reference.

TABLE 5

| | |
|---|---|
| Modifier alloy | Hcj(kOe) |

| composition | Vacuum heat | Ar atmosphere |
|---|---|---|
| (at %) | treatment | heat treatment |
| Nd-92 at % Ga | 8.4 | 7.9 |
| Nd-50 at % Ga | 12.3 | 12.3 |
| Nd-45 at % Ga | 12.3 | 12.3 |
| Nd-40 at % Ga | 12.4 | 10.1 |
| Nd-30 at % Ga | 13.7 | 9.8 |
| Nd-25 at % Ga | 14.9 | 11.7 |
| Nd-20 at % Ga | 19.5 | 13.6 |
| Nd-14 at % Ga | 20.3 | 14.4 |
| Nd-10 at % Ga | 20.1 | 13.9 |
| Nd-5 at % Ga | 15.4 | 13 |
| Nd-0 at % Ga | 12.4 | 12.4 |
| Not modified | 12.4 | 12.5 |

Note:
For conversion of the unit of coercive force kOe into the International System of Unit (SI) (kA/m), the coercive force was calculated by multiplying it by 79.6.

It can be found from Table 5 and FIG. 14 that when Ga is 5 to 30 at % at 1.33×10⁻⁴ Pa and with the vacuum heat treatment, the effect of improving a coercive force is extremely high, and among them, the effect is the highest with Nd-14 at % Ga, followed by 10 at % Ga and 20 at % Ga. If the amount of Ga falls below 5 at %, the melting point of the alloy increases beyond the heat treatment temperature, meaning that melting of the alloy cannot proceed greatly and the amount of diffusion is small, resulting in small improvement in Hcj. On the other hand, if the amount of Ga exceeds 30 at %, the melting point increases similarly, and so diffusion becomes difficult. Even when it is diffused, a large amount of such Ga penetrates into the grain boundary phase, a part of which is substituted with Fe in the main phase. Then, such Fe substituted in the main phase will be discharged to the grain boundary phase, which causes an increase in density of Fe in the grain boundary phase, and so it is no longer an ideal non-magnetic grain boundary. That is, a large effect of improving a coercive force can be expected in the range of Ga from 3 to 30 at %, desirably 5 to 20 at %.

Meanwhile, such an effect was limited in the case of Ar atmosphere. In the case of vacuum treatment, Ga is evaporated during the heat treatment, while Nd is mainly diffused. On the other hand, in the case of treatment in the Ar atmosphere at the atmospheric pressure, the alloy Ga is diffused into the magnet while keeping the density thereof. Then, such Ga is substituted with Fe and Co in the main phase, and so Fe and Co will be discharged to the grain boundary phase. As a result, anisotropy magnetic field in the main phase deteriorates, and their magnetic separation also deteriorates because the density of Fe and Co increases in the grain boundary phase. In this way, a large effect of improving a coercive force cannot be expected. Although, in most of the embodiments disclosed in Patent Literature 1, the amount of rare-earth elements of an alloy for diffusion is very small, the effect of improving a coercive force will not be expected even when a modifier alloy of such composition is used in this experiment.

Next, the thickness of a two grain boundary of the rare-earth sintered magnets manufactured in this experiment was measured for confirmation on photos with the magnification of ×30,000 ((1) average of ten points fro average two grain boundary, (2) the maximum thickness of the two grain boundary), while making an analysis with EDS of FE-SEM about the amount of Ga contained at the center position of the two grain boundary and the position of a main phase in the vicinity of the grain boundary in the range of 100 μm from the surface of the magnet. Table 6 below shows the result of the measurement.

TABLE 6

| | | Grain boundary phase | | | Thickness of grain | |
|---|---|---|---|---|---|---|
| | | element density (at %) | | | boundary phase (nm) | |
| Heat | Nd—Ga | Grain boundary | | Grain boundary | Average | Maximum |
| treatment | alloy | phase | Main phase | phase Fe + Co | two grain | two grain |
| atmosphere | composition | Ga density | Ga density | density | boundary | boundary |
| Vacuum | Nd-5 at % Ga | 0.4 | 0 | 22 | 12 | 54 |
| | Nd-14 at % Ga | 2.1 | 0.3 | 38 | 19 | 72 |
| | Nd-20 at % Ga | 3 | 0.6 | 61 | 19 | 85 |
| | Nd-30 at % Ga | 3.3 | 0.9 | 68 | 14 | 46 |
| | Nd-40 at % Ga | 4 | 2 | 71 | 6 | 16 |
| | Nd-92 at % Ga | 30.9 | 3 | 81 | 5 | 21 |
| | (Comp.)before | 0 | 0 | 74 | 2 | 3 |
| | treatment | | | | | |
| Ar | Nd-5 at % Ga | 1.3 | 0.2 | 73 | 3 | 4 |
| gas | Nd-14 at % Ga | 6.7 | 2.4 | 72 | 9 | 8 |
| | Nd-30 at % Ga | 11.8 | 6.7 | 82 | 9 | 14 |
| | Nd-92 at % Ga | 52.3 | 13.5 | 88 | 7 | 9 |

Note:
Density was measured at ten points for each by point analysis with EDS through observation with ×30,000 of FE—SEM.

It can be found from the result of Table 6 that a rare-earth sintered magnet manufactured in this experiment having a higher coercive force contained less amount of Ga in the grain boundary and in the main phase, and the density of Fe+Co also was less than 70 at %.

Such density results from the amount of Ga in the alloy, the melting point, and the vacuum atmosphere (evaporation of Ga). The above result shows that, in the case of a magnet having a large coercive force in this experiment, Nd—Ga melts in the vacuum, and Ga having small specific gravity moves upward in the melt pool and when it reaches the top, then evaporation starts. Then, the molten Nd and the small amount of Ga separated enter into the grain boundary phase soon. Then, the thus manufactured magnet has a very thick two grain boundary after the heat treatment as the post process, and less than 1 at % of Ga only is substituted in the main phase, and so the characteristics of a Nd₂Fe₁₄B are not degraded greatly. Substitution with Fe is less, and so the amount of elution of Fe from the main phase to the grain boundary phase also is less, meaning that fresh Nd (containing small amount of Ga) diffused from the modifier alloy forms a grain boundary phase with small density of Fe. Such a grain boundary phase can block the movement of magnetic walls with such a thickness and small density of Fe reliably for pinning of magnetization reversal. In this way, the coercive force increases conceivably.

[Experiment to Examine the Relationship Between Grain Size of Main Phase and Coercive Force, and Result Thereof]

The present inventors further conducted an experiment to specify the relationship between the size of a main phase of a rare-earth sintered magnet and a coercive force. Specifically the degree of grains to be ground with a jet mill in the experiment as stated above was changed, and the effect thereof was checked.

Powder was oriented while applying magnetic field of 20 kOe thereto in the atmosphere of the oxygen density of 0.5 ppm to form a compact, which was then sintered for 2 hours at 1,040° C. The sintered product had the same shape as that was prepared in the experiment as stated above. Then a thin plate of Nd-14% Ga of 75×15×0.4 mm in size (corresponding to 8 mass %) that had the largest effect based on Table 5 was disposed on the magnet, followed by a diffusion heat treatment at 950° C. for 15 hours and a low-temperature heat treatment at 500° C. Table 7 below and FIG. 15 show the levels of grinding with a jet mill and the measurement of Hcj after the treatment.

TABLE 7

| Nd—Fe—B | (Comp.) | | |
|---|---|---|---|
| Average | Without | Diffusion + | Improvement in |
| grain size | diffusion | heat treatment | coercive force |
| (μm) | Hcj(kOe) | Hcj(kOe) | ΔHcj(kOe) |
| 1.3 | 13.2 | 21.2 | 8 |
| 2.4 | 13.6 | 21.5 | 7.9 |
| 3.5 | 12.3 | 20.3 | 8 |
| 5.2 | 11.5 | 16.8 | 5.3 |
| 8 | 9.6 | 14.4 | 4.8 |
| 10.6 | 9 | 10.7 | 1.7 |
| 18.6 | 7.8 | 8.7 | 0.9 |

Note:
Average grain size was the mass median diameter.

It can be found from Table 7 and FIG. 15 that powder having smaller degree of grains has a larger effect of improving the coercive force in this experiment. When the manufacturing method of the present invention is used, the effect will be noticeable when the main phase thereof has a smaller grain size. Conversely when the main phase has a size exceeding 10 μm, the effect was small, and as a result of examining the appearance of the magnet having such a small effect, the alloy for diffusion partly remained on the surface of the magnet without being diffused.

The reason why powder having a smaller grain size leads to a larger effect of improving the coercive force can be considered a Nd-rich phase in the diffused alloy penetrating into the magnet more uniformly in the powder having a smaller grain size due to capillary action. Grain sizes of 2.4 μm and 1.3 μm are smaller than columnar crystallite of dendrite by strip casting, and so the amount of a Nd-rich phase between dendrites (the thickness of a dendrite is 2 to 5 μm) is small, or the Nd-rich may not be present partly. That is, when it is sintered in this state, magnetic separation due to Nd-rich phases is not enough at the main phase, and so the effect of improving the coercive force is small with a fine main phase. Then, Nd is diffused to the grain boundary phase at a later process so that such a part of insufficient magnetic separation also can penetrate into the Nd-rich grain boundary phase to enable the separation, whereby the effect from finer crystals can be exerted. When the grain size is finer than them, they may be coarse during sintering, or when sintering can be performed, they may be coarse during a heat treatment, meaning a failure to form a desired structure.

Although the embodiments of the present invention have been described in details with reference to the drawings, the specific configuration is not limited to these embodiments, and the design may be modified without departing from the subject matter of the present invention, which falls within the present invention.

### REFERENCE SIGNS LIST

M Rare-earth sintered magnet
S Surface
SA Area at surface layer
C Main phase (crystals, crystalline grains)
B Grain boundary phase
CA Center area

1-3. (canceled)

4. A method for manufacturing a rare-earth sintered magnet including: a RE-T-B main phase (RE: Nd or Pr, T: Fe or Fe and a part thereof substituted with Co), and a grain boundary phase surrounding the main phase, the grain boundary phase including the RE element and the T element, the T element at the grain boundary phase having density of 60 at % or less, and the grain boundary having a thickness decreasing from a surface of the rare-earth sintered magnet to an inside thereof, comprising:
a first step of press-forming powder including the main phase and the grain boundary phase to prepare a sintered body: and
a second step of bringing a RE-M alloy (M: a metal element that has a vapor pressure of 1.33×10⁻² Pa or less at the temperature of 950° C., and has a melting point in the form of a RE-M alloy that is 800° C. or less) into contact with the sintered body, followed by a heat treatment at a temperature that is higher than a vapor pressure curve of the M element by 50 to 200° C., and then letting melt thereof diffuse for penetration into a compact, thus manufacturing the rare-earth sintered magnet.

5. The method for manufacturing a rare-earth sintered magnet according to claim 4, wherein the M element includes any one type or two types or more of Ga, Mn and In.
